(19) United States
(12) Patent Application Publication
(10) Pub. No.: US 2008/0314012 A1
(43) Pub. Date: Dec. 25, 2008

(54) Filter Elements

(75) Inventor: Richard Frazer Allen, West Yorkshire (GB)

Correspondence Address: BARLOW, JOSEPHS & HOLMES, LTD., 101 DYER STREET, 5TH FLOOR, PROVIDENCE, RI, 02903, US

(73) Assignee: MADISON FILTER 981 LIMITED, Lancashire (GB)

(21) Appl. No.: 12/090,093

(22) PCT Filed: Oct. 27, 2006
(86) PCT No.: PCT/GB2006/003999

§ 371 Date: Aug. 22, 2008

(30) Foreign Application Priority Data
Oct. 27, 2005 (GB) 0521910.0

(51) Int. Cl. B01D 46/24; B01D 39/20

(52) U.S. Cl. 55/524; 55/527; 264/274

(57) ABSTRACT

A ceramic filter element is formed from a flocculated slurry predominantly containing inorganic fibres, of 100-150 μm length and 1-5 μm thickness. The slurry also contains inorganic yarn in lengths of from 10 mm or greater, e.g. 10-150 mm and thickness 0.1-0.5 mm diameter. The slurry is formed in water with colloidal silica and starch added to flocculate the slurry. The flocculated slurry is then injected to a mould comprising an appropriately shaped mesh form, and water removed by vacuum, and the filter thus formed dried in an oven for 8-12 hours at 120° C. The addition of yarns, which may be glass or alumina mono or multifilament yarns, increases the shock resistance of the ceramic filter element produced.

This invention relates to an improved filter element, in particular a ceramic filter element for use for example in gas filtration.

Gas filtration elements which have to withstand high temperatures such as encountered in furnace flues are conventionally made of ceramic material because of its inate resistance to high temperatures. These usually take the form of tubes with an open end for admission of dust laden gas, and a closed end, often referred to as candle shaped filters.

The filter elements can be composed of inorganic fibres, made by an injection moulding process, as described in WO 03/090900. The inorganic fibres may comprise ceramic fibres, crystalline mineral fibres, amorphous mineral fibres, mineral wool, glass fibres and other fibres with refractory properties. The ceramic fibres may include fibres comprising alumina, alumino-silicate, calcium silicate or other silicates. Porosity of 70-80% may be attained due to the low density distribution of the fibres, even when a catalyst or other reactant is entangled in the fibres.

Filter elements so made are excellent at particle retention, but are of low strength, due to their high porosity and are susceptible to fracture due to fragility and low shock resistance when in place in the filter installation, leaving part of the filter element in place in the mounting, and one or more other parts having fallen into a trap provided for the dust, and needing to be recovered. Dipping the filter in silica can reinforce the filter body against shock, but this tends to clog the pores in the body and thus increases the energy needed to draw air through the filter, and the element has reduced effectiveness as a dust filter. It has been proposed in WO 05/072848 to include a metal cage in the filter structure, but this solution is expensive, and can cause damage to the surface of the filter element.

Another approach is to use alternative fibres such as needle-shaped crystals of minerals such as wollastonite as proposed in GB A 2,298,591. This however gives only a small increase in strength and the element remains brittle.

Finally it is possible to use an all-metal filter, e.g. of metallic fibres, but such a filter is both very heavy and expensive.

It is accordingly an objection of the invention to provide an improved filter construction which will have significantly improved resistance to breakage with increased toughness, without impairing the porosity, weight or filtration characteristics of the filter, and which if it fails by cracking or fracturing, will remain in one piece, so that it can be recovered easily and will achieve this in a relatively economical manner.

According to the invention, a filter element is manufactured from a material which comprises predominantly inorganic fibres, characterised in that the material also includes a quantity of inorganic yarn, in lengths of 10 mm or greater.

The terms “inorganic fibres” and “inorganic yarns” are intended to include bulk fibres, or yarns of ceramic materials, rock or mineral wools, crystalline or amorphous fibres, glass fibres and other fibres with refractory properties. Ceramic bulk fibres and yarns may include those comprising alumina, alumino-silicate, calcium silicate and other silicates. The yarns used may be spun from filaments or threads to make up multi-filament or staple yarns or be of extruded monofilament fibres.

The yarns may be provided in lengths from 100 mm up to 150 mm, and 0.1-0.5 nm diameter, in a typical case having a mean length of about 50 mm. The bulk fibres may typically be from 100-500 μm in length and 1-5 μm in thickness.

The yarns preferably comprise a minor quantity in the filter composition, for example in the order of 1/30^{th} by weight of the ceramic bulk fibres present. Other components may include a quantity of non-fibrous alumina, some colloidal silica, and a starch solution. These may be added to water to form a flocculated slurry for forming the filter element by an injection moulding process.

The invention also provides a method of making such a filter element comprising forming a slurry which predominantly comprises inorganic fibres, characterised in that the material also includes a quantity of inorganic yarn in lengths of 10 mm or greater. The Slurry may be flocculated, as mentioned above.

The slurry may be formed into candle-shaped filter elements by forming the bulk fibres, yarns, etc onto an appropriately shaped wire mesh form while water is drawn away and removed by vacuum. The wet formed filter element may then be taken from the mould and dried in an oven.

The oven may dry the element for 8 to 12 hours at 120° C.

For example a filter element made by this preferred method may be 1 to 3 metres in length, with an outer diameter of 60 to 150 mm. Generally, shorter filters also are of smaller diameter. The element may comprise a hollow tube which is closed at one end, and may have a wall thickness of from 10 to 20 mm, the greater thicknesses generally being provided for longer and wider filters. The open end of the tube may have an outwardly extending flange to allow the filter element to be clamped into the filtration equipment.

It is well known that un-reinforced filter elements are both brittle and weak. However, as the elements are usually filtering very small, lightweight particulates from gas streams, they do not usually fail because the strength of the material is compromised by typical operation. Instead, elements are more likely to fail due to unexpected mechanical shock (e.g. sudden large vibrations), which break elements because they are brittle. Toughening the elements with long yarns in accordance with the invention, at the expense of small loss of strength, gives filter elements that are much less likely to fail due to mechanical shock, while still being unlikely to fail in normal duties.

This toughness is not the same as the material strength, which is a measure of the peak stress at which facture occurs. By incorporating long yarns, with appropriate kinds and amounts of yarn, toughness can be significantly increased without substantially impairing the strength of the material.

A preferred embodiment of filter element and method of making the same in accordance with the invention will now be described by way of example, with reference to the accompanying drawings, wherein:—

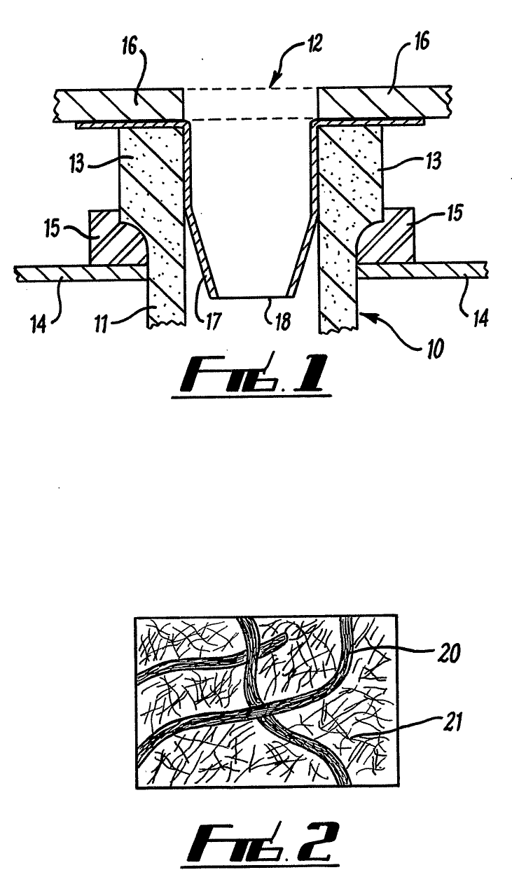

FIG. 1 is a sectional view of the open end of a filter element according to the invention, in place in filtration apparatus; and

FIG. 2 is an enlarged schematic view of a part of the interior of the filter element wall illustrating the composition thereof.

A filter element 10 according to the invention comprises a generally cylindrical hollow body 11, with a closed end (not shown) and an open end 12, formed with a flange 13. This is shown in-situ in a filtration machine, engaged with a tube sheet 14 with a sealing gasket 15, and a clamping plate 16 which presses the flange 13 against the tube sheet 14 through the gasket. An insert 17 provides a venturi 18. This configuration is of a type well known in the art.

FIG. 2 shows a schematic much magnified detail view of part of the element 10. This comprises a few long thick yarns 20, and a considerable mass of felted bulk fibres 21 which entangle with each other and with the yarns 20. Both the yarns and the bulk fibres are of inorganic material, in the preferred embodiment a ceramic material such as an alumino-silicate.

In making the filter element 10, a slurry, comprising the fibres 21 and the yarns 20 together with other ingredients and a flocculating agent, is formed on a fine metal mesh cylinder by injection moulding, and excess liquid, mainly water, from which the slurry is drawn through the mesh to be exhausted and to leave the bulk fibres and yarns in a mass on the mesh cylinder screen. The mass is then removed and inserted into a mould to produce an elongate cylindrical filter element with a closed end, and an open end.

The wet filter element thus formed is taken from the mould, and dried in an oven for 8 to 12 hours at 120° C.

In a preferred example, a slurry from which the filter element 10 is moulded may be made up as follows: —

| | | |
|---|---|---|
| Water | 1000 | kg |
| Ceramic Bulk Fibre | 15 | kg |
| Ceramic Yarn | 0.5 | kg |
| Alumina | 1.47 | kg |
| Colloidal silica | 3.69 | kg |
| Starch solution | 20 | kg |

The ceramic bulk fibres range from 100 to 500 μm in length, and are of 1 to 5 μm diameter.

The ceramic yarns are chopped into lengths of 50 mm, but could be from 10 to 150 mm in length, and are typically 0.1 to 0.5 mm in thickness, (i.e. comparable to the length of the bulk fibres).

The ceramic bulk fibres and yarn pieces are distributed in the water, to which is added an inorganic binder such as colloidal silica. An optional filler in powder form, which may be inert, as for example alumina, or reactive such as activated carbon or a catalyst, can also be added, and the mixture stirred to mix all the solid ingredients and allow the inorganic binder to coat the bulk fibres, yarns and powder.

The slurry is then flocculated by adding the starch solution, which is preferably cationically modified, whilst continuing stirring.

Other flocculent material, such as a polymeric flocculent e.g. polyacrylamide may be used also or instead.

The filter element 10 produced by this method from the slurry may be 1 to 3 metres in length and from 60-150 mm in diameter, and is a typical ‘candle’ shape comprising a tube having a closed end and an open end, and may have a wall thickness of 10 to 20 mm.

The flocculation of slurries which contain only bulk fibre, but not yarns, produces small discrete flocculations, of say 5-50 nm diameter. When long yarns are added the flocculations are loosely bound together by the long yarns. When the filter elements are moulded, the discrete flocculations are compressed together first by the pressure of the slurry and then by the vacuum. The funnel filter element is then held together because of the binding between fibres and flocculations caused by the colloidal silica and starch. When the slurry contains additional long yarns, loosely bound groups of flocculations are compressed together, resulting in the same binding by colloidal silica and starch, but with additional entanglement of the yarns and fibres (e.g. as in FIG. 2). This additional entanglement manifests itself as improved material toughness.

The yarns and bulk fibres may be made of any suitable inorganic material such as ceramic materials, rock or mineral wools, crystalline or amorphous fibres, glass fibres and other fibres with refractory properties. Ceramic bulk fibres or yarns may include those comprising alumina, alumino-silicate, calcium silicate and other silicates. The bulk fibres and yarns may be of the same material or of different materials.

The standard, un-reinforced ceramic filter elements of the prior art are relatively brittle in that as a compressive or tensile load is applied it does not cause much displacement before it breaks. In other words, the mechanical stress increases very quickly compared to the mechanical strain. Also, once enough stress has been applied to cause a fracture, the un-reinforced material will not usefully absorb any more stress. Further movement (i.e. increased strain) results in very low stress values, which are of no practical use and mean that in operation the filter elements fall apart.

By incorporating long yarns, which entangle within the body of the filter element (as FIG. 2) toughness is increased because after a fracture, even with increasing strain, the material will still withstand significant amounts of stress. In practical terms, the element holds together and continues to function.

All of this is different to the material strength, which is a measure of the peak stress (i.e. in brittle materials such as ceramics, the stress at which fracture occurs). With the long yarns, the invention comes from adding the right type and amount of yarn so that toughness is significantly increased without compromising the strength too far.

By making laboratory samples of the filter element material, it has been found that the material which makes un-reinforced ceramic filter element will fracture at very low strains e.g. 2-3% and further strain gives quickly diminishing stresses. To demonstrate this, we have values for the peak stress of various materials, as well as the stress measured beyond the fracture strain.

Laboratory tests were done by preparing a sample of the slurry mixture of the preferred example above to 0.2% of the amounts cited, so that it comprised 2 kg water, 0.03 kg bulk fibre and proportionate amounts of the other ingredients. The slurry was made in the same manner, except that Type 1 or Type 2 yarns were added to the water at the same time as the bulk fibre and mixed very thoroughly to disperse the yarns within the bulk fibres before further ingredients were added.

Once the slurry was flocculated, the solids were formed onto a horizontal metal screen (100×100 mm) by pouring the slurry on top at the same time as a vacuum was applied below the screen. The vacuum removed the majority of the water, leaving wet tiles which were subsequently dried in the oven at 120° C. for 8 hours. The dried tiles were then be subjected to stress/strain fracture testing.

The tables below show two different types of fibres (Type A—glass monofilament, Type B—alumina multifilament); the Type A fibre has been added as two different lengths—90 and 45 mm:

TABLE 1
Fibre type A1-
90 mm mono-filament glass yarns

| Additional percent weight | Peak failure stress/ | Stress at 6% strain/ |
|---|---|---|
| of yarn/% | kNm⁻² | kNm⁻² |
| 0 (30 g bulk, 0 g yarn) | 0.37 | 15 |
| 1 (30 g bulk, 0.3 g yarn) | 0.30 | 50 |
| 2 (30 g bulk, 0.6 g yarn) | 0.30 | 65 |
| 3 (30 g bulk, 0.9 g yarn) | 0.28 | 110 |
| 5 (30 g bulk, 1.5 g yarn) | 0.22 | 100 |
| 10 (30 g bulk, 3.0 g yarn) | 0.13 | 110 |

TABLE 2
Fibre type A2-
45 mm mono-filament glass yarns

| Additional percent weight | Peak failure stress/ | Stress at 6% strain/ |
|---|---|---|
| of yarn/% | kNm⁻² | kNm⁻² |
| 0 (30 g bulk, 0 g yarn) | 0.37 | 15 |
| 5 (30 g bulk, 1.5 g yarn) | 0.23 | 140 |
| 10 (30 g bulk, 3.0 g yarn) | 0.21 | 160 |

TABLE 3
Fibre type B-
50 mm twisted multifilament alumina yarns

| Additional percent weight | Peak failure stress/ | Stress at 6% strain/ |
|---|---|---|
| of yarn/% | kNm⁻² | kNm⁻² |
| 0 (30 g bulk, 0 g yarn) | 0.37 | 15 |
| 15 (30 g bulk, 4.5 g yarn) | 0.25 | 80 |
| 20 (30 g bulk, 6.0 g yarn) | 0.29 | 80 |
| 50 (30 g bulk, 15.0 g yarn) | 0.31 | 240 |

It can be seen from Table 1, that adding more yarn dramatically increases the toughness of the material. This is shown because the stress at 6% strain increases by almost a factor of eight when 3% yarn is included. Unfortunately, along with increased toughness there is a strength penalty as the peak failure stress decreases as the amount of yarn increases. Further additions of Type 1 fibre, beyond 3%, are ineffective as this induces forming problems when dewatering the slurry—in effect the slurry contains too few flocs loosely bound to too many yarns. Hence, when a tile is formed it has defects and no further toughness gains are possible.

However, by using shorter Type 1 yarns in Table 2 (45 mm instead of 90 mm) the point at which forming problems inhibit further gains in toughness can be extended (possibly as far as 10% additional yarn). Therefore, when 5% of the shorter Type 1 yarn is added, the material is both tougher and marginally stronger than when the equivalent amount of long yarn is used.

Turning to Type 2 yarns, the amount of yarn that can be added to the bulk fibre is greater than for Type 1. However, the same trends are demonstrated, namely, more yarn gives larger increases in toughness with an increasing strength penalty

1. A filter element which is manufactured from a material which predominately comprises inorganic fibres, characterised in that the material also includes a quantity of inorganic yarn in lengths of 10 mm or greater.

2. A filter element according to claim 1, wherein the yarn comprises mono-filament glass yarns.

3. A filter element according to claim 1, wherein the yarn comprises multifilament alumina yarns.

4. A filter element according to claim 1 wherein the yarns are of lengths from 10 mm to 150 mm, and in the range 0.1-0.5 mm diameter.

5. A filter element according to claim 1, wherein the inorganic fibres are from 100-150 μm in length and from 1 to 5 μm in thickness.

6. A filter element according to claim 1 wherein the yarns comprise in the order of 1/30^{m} by weight of the inorganic fibres.

7. A filter element according to claim 1 which further includes a quantity of non-fibrous alumina, colloidal silica and a starch solution which are added to water to form a flocculated slurry for use in forming the filter element.

8. A filter element according to claim 7, wherein the slurry is formed into the filter element by injection moulding.

9. A method of making a filter element comprising forming a slurry which predominantly comprises inorganic fibres, characterised in that the material also includes a quantity of inorganic yarn in lengths of 10 mm or greater.

10. A method according to claim 9, wherein the slurry is flocculated using colloidal silica and a starch solution.

11. A method according to claim 10, wherein the flocculated slurry is injected into a mould formed by an appropriately shaped wire mesh form, the water in the slurry drawn off and removed leaving the fibres deposited on the wire mesh form, to leave a wet-formed filter element.

12. A method according to claim 11, wherein the wet-formed filter element is then taken from the mould and dried in an oven for 8 to 12 hours at 120° C.
